(19) United States
(12) Patent Application Publication
(10) Pub. No.: US 2016/0239473 A1
(43) Pub. Date: Aug. 18, 2016

(54) Method and System for Auto-Populating Smart Templates with Data from Multiple Sources with Structured and Unstructured Data

(71) Applicants: Ronny Shapiro, Palo Alto, CA (US); Gilad Foyer, Palo Alto, CA (US)

(72) Inventors: Gilad Foyer, Nes Ziona (IL); Ronny Shapiro, Tel Aviv (IL)

(73) Assignee: DUDA, INC., Palo Alto, CA (US)

(21) Appl. No.: 14/621,001

(22) Filed: Feb. 12, 2015

(51) Int. Cl. G06F 17/24; G06F 17/22; G06F 17/21

(52) U.S. Cl. CPC G06F 17/248; G06F 17/212; G06F 17/2247

(57) ABSTRACT

A smart template is a data structure that may be utilized in a website authoring, storage and management system. The smart template may include program instructions and content. The program instructions may be based on rules in order to control selection, formatting and display of content. The content may be structured or unstructured data.

### BACKGROUND OF THE INVENTION

1. Field of the Invention

The invention relates to methods and systems for assembly of data and particularly for creation of pages suitable for display through a web browser.

2. Description of the Related Technology

U.S. Pat. No. 8,196,035, entitled Adaptation of a Website to Mobile Web Browser, the disclosure of which is expressly incorporated herein shows a system for harvesting data from a website and formatting the data for display in a mobile web browser.

There are platforms available, such as WordPress and Squarespace for website content management. These content management platforms require a high level of author interaction and management to prepare, assemble, format and present web content.

### SUMMARY OF THE INVENTION

It is an object of the invention to provide a simplified website authoring tool and content management system.

It is an object of the invention to provide a method and system for auto-populating smart templates.

It is an object of the invention to auto-populate smart templates with data from disparate sources.

It is an object of the invention to auto-populate smart templates with structured and unstructured data.

It is an object of the invention to provide a system and method that starts with existing web content and uses that content and the properties of a smart template to populate the template with some or all of the existing web content and to add additional content suggested by the existing content.

It is an object of the invention to populate the smart template with unstructured content contained in the existing content, unstructured content suggested by the existing content, structured content contained in the existing content and/or structured content suggested by the existing content.

It is an object of the invention to provide a smart template having a data memory containing a plurality of memory cells programed to define a structured data template; and a plurality of memory cells set to define one or more containers in the structured data template. A plurality of memory cells may be associated with said one or more containers set to contain program instructions. The program instructions may contain one or more rules controlling the content loaded to the container(s). A plurality of memory cells may be set to contain content according to the rules. The plurality of memory cells set to contain content may be set to contain structured and/or unstructured data. The rules may include rules to identify content and use the identification to control the container. The rules may include rules to classify content and use classification to control a container. The rules may include rules to manipulate content and store manipulated content in one or more of said containers.

Structured data is data that resides in a known format. Unstructured data is data that does not reside in a known format. Unstructured data files often include text and multimedia content. Examples of unstructured data include email messages, word processing documents, videos, photos, audio files, presentations, web pages. Note that while these sorts of files may have an internal structure, because the data format is not fixed and may be complex they are considered unstructured.

Additional sources of unstructured data applicable here include data obtained from social networking sources and data obtained from many html-based web pages.

Sources of structured data particularly relevant to the present system and method include directory-based data such as telephone number and address directories.

A smart template is a data structure that includes programming logic controlling the selection and formatting of content.

A smart template is an active data structure that may be compatible with one or more display modes. For example display, a computer monitor mode; a tablet mode; and a smart phone mode. The smart template may be compatible with any number of display sizes and/or shapes.

The system may be directed to a data source such as a website URL or a Facebook page. The system operates to harvest data from the data source and uses the information obtained to locate additional data for incorporation into the template.

For example if the system identifies a company name in the data source, it may execute a directory lookup to determine a telephone number and address.

The telephone number and address may be added to the template. The address may be used to find a map showing the location and surrounding area. The map may also be incorporated into the template. Alternatively a URL may be added to the template to retrieve the map data each time the web page is retrieved.

Other examples of data that can be used to locate further data for incorporation into a presentation template include:

| Identified Data | Other Data Source |
|---|---|
| Name | Contacts |
| Location | Pictures, Webcam images |
| Conditions | Weather Forecast |
| Contacts | Connections |
| Company Name | Investor Information |

Various objects, features, aspects, and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 illustrates an embodiment of a system including a smart template.

FIG. 2 illustrates an embodiment of a smart template system.

### DETAILED DESCRIPTION OF PREFERRED EMBODIMENTS

Before the present invention is described in further detail, it is to be understood that the invention is not limited to the particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein.

It must be noted that as used herein and in the appended claims, the singular forms “a”, “an”, and “the” include plural referents unless the context clearly dictates otherwise.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates, which may need to be independently confirmed.

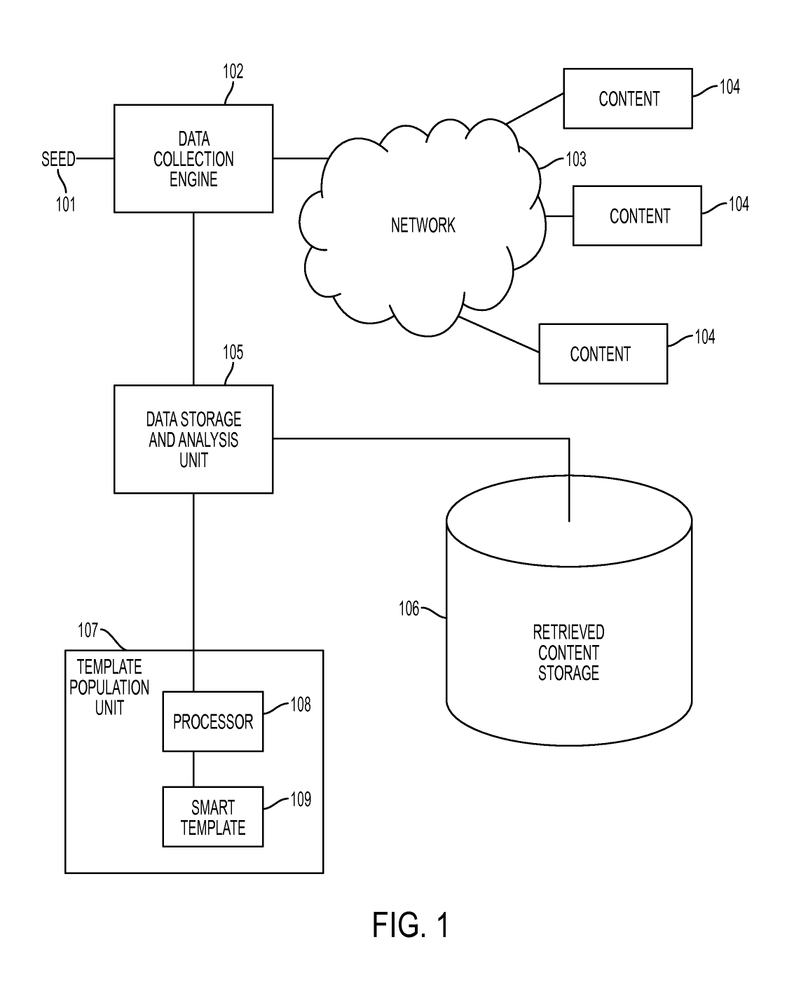

According to an embodiment of the invention, FIG. 1 shows an advantageous process for constructing network resources. The network resources may be in the form of a web page or pages. Initially a seed 101 is provided to a data collection engine 102. The seed 101 is utilized to initiate a search for content. The seed generally identifies the subject of the resource to be constructed. In the case of a corporate website, the seed 101 may be the corporate name or domain name. Other seeds may be used to construct network resources by collection of content related to the seed identification. The search engine 102 advantageously may implement program logic and rules in order to initiate queries based on the seed.

The queries may be for structured or unstructured data. The data collection engine 102 may be connected to a network 103, for example the internet. The data collection engine 102 may issue queries through the network 103 to one or more content providers 104. The content providers 104 may be dedicated or general purpose. A dedicated content provider may return a known content type in response to a predetermined query format. For example, the content provider 104 may provide content in the form of a map in response to a query on an address. Other examples could be telephone directories or weather services. A general purpose content provider is typically more flexible, but the returned content is less predictable. For example, a search engine, such as Google, may operate as a content provider and in response to a search term yield a reference description and URL for one or more additional resources. The data collection engine 102 may have sufficient intelligence and/or rules to enable it to seek additional content based on URLs or any other content returned by a content provider.

The data storage and analysis unit 105 may access the retrieved content from the data collection engine 102. The data storage and analysis unit 105 may be a rule-based system that may analyze content such as content accessed by the data collection engine 102, ascertain if the content is potentially useful, determine if the content satisfies a rule and/or may be used to seek collection of additional content. The data storage and analysis unit 105 may communicate with the data connection engine 102 in response to content received, which in turn may issue further queries to one or more content providers 104 through network 103.

The data storage and analysis unit 105 stores content in database 106. The template population unit 107 includes a processor 108 and smart template 109.

The template population unit 107 may be connected to database 106 in order to access retrieved content. The template population unit 107 may be connected to the data storage and analysis unit 105 in order to trigger further queries for data collection.

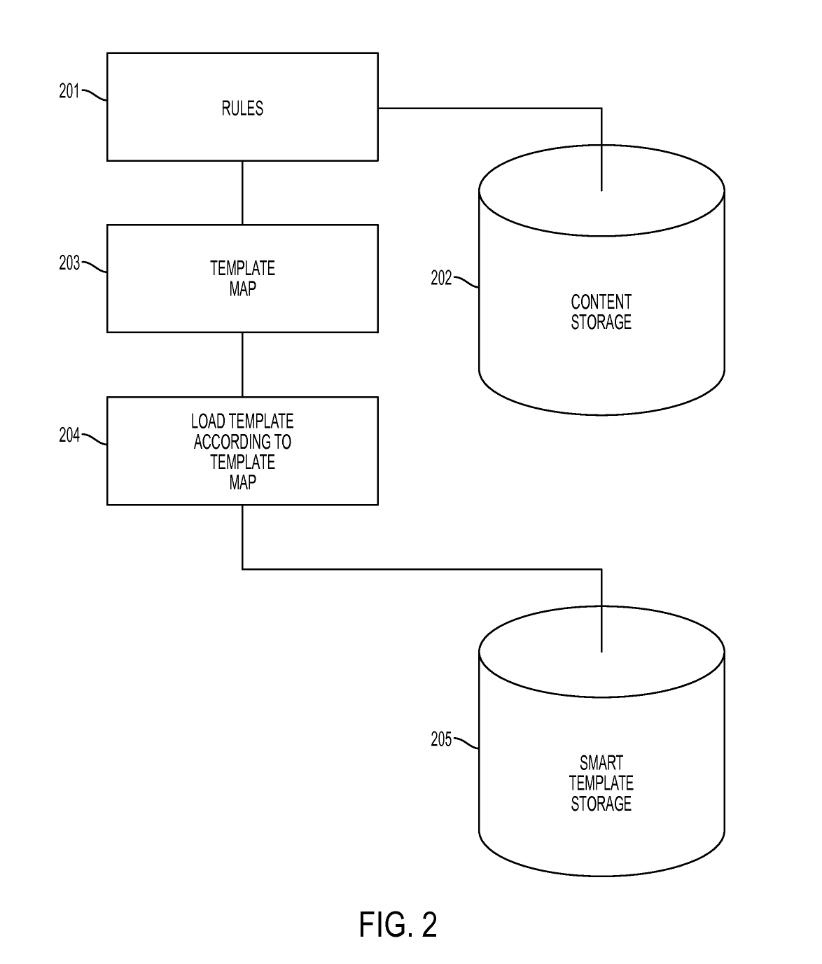

FIG. 2 shows an example of the operation of a smart template 109. The smart template may be a data structure that includes program instructions 110. The program instructions 110 may include rules 201. The rules 201 may rely on a template map 203 and may operate on data contained in database 202. Database 202 may include indexed content for potential inclusion in the smart template. Database 202 may be the same as database 106 and/or may include content from database 106. Database 202 may include query responsive content and default content. The rules 201 may initiate a query to the database for collected content corresponding to an area specified by the template map 203. The rules 201 may retrieve collected content for a particular portion of a template map if available in database 202. If the requested content is not available in database 202, the rules may retrieve default content for such portion. The smart template 109 may also include program instructions to control loading the template according to the template map with content retrieved from database 202. The smart template 109 may be stored in database 205. Database 202 and 205 need not be separate physical units and may be included in a single database management system.

According to a preferred embodiment, logic may be provided to pre-populate a template to manage web content. The system may examines pre-existing content and may use a rule-based approach for the pre-population. A default format may be used or a user may select a format or style. The format may be used as or incorporated into a content map.

Advantageously, an operator or designer can modify or supplement certain aspects of the content and format.

The system may use an identifier indicating the platform configuration in order to manage content so that it is consistently rendered across platforms.

Advantageously, content in the smart template may be divided into elements. Any element may be edited, moved or restyled. Elements may also be added or removed. Various features may be organized as elements. Examples are tables, headings, paragraphs, buttons and media.

The theme of the content may also be modified. Theme modifications may apply across elements and may include color, font, buttons, navigation options, etc.

Thus, specific apparatus for and methods of auto-populating smart templates with data from multiple sources with structured and unstructured data have been disclosed. It should be apparent, however, to those skilled in the art that many more modifications besides those already described are possible without departing from the inventive concepts herein. The inventive subject matter, therefore, is not to be restricted except in the spirit of the disclosure. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A smart template comprising:
a data memory containing a plurality of memory cells programed to define a structured data template;
a plurality of memory cells set to define one or more containers in said structured data template;
a plurality of memory cells associated with said one or more containers set to contain program instructions, wherein said program instructions contain one or more rules controlling the content loaded to said one or more containers;
a plurality of memory cells set to contain content according to said rules.

2. A smart template according to claim 1 wherein said plurality of memory cells set to contain content are set to contain structured data.

3. A smart template according to claim 2 wherein said plurality of memory cells are set to define one or more containers for storing unstructured data.

4. A smart template according to claim 3 wherein said plurality of memory cells set to define one or more containers further comprise a plurality of memory cells set to define one or more containers for storing unstructured data.

5. A smart template according to claim 2 wherein said plurality of memory cells set to define one or more containers are set to define one or more containers for storing unstructured data.

6. A smart template according to claim 1 wherein said rules further comprise rules to identify content and use the identification to control the container.

7. A smart template according to claim 1 wherein said rules further comprise rules to classify content and use classification to control a container.

8. A smart template according to claim 1 wherein said rules further comprise rules to manipulate content and store manipulated content in one or more of said containers.
